(19) United States
(12) Patent Application Publication
(10) Pub. No.: US 2012/0246180 A1
(43) Pub. Date: Sep. 27, 2012

(54) PORTABLE DEVICE

(76) Inventors: Shinichi Yoshida, Kawasaki-shi (JP); Ito Makoto, Toda-shi (JP); Fumiki Nakamura, Yokohama-shi (JP)

(21) Appl. No.: 13/417,535

(22) Filed: Mar. 12, 2012

(30) Foreign Application Priority Data
Mar. 22, 2011 (JP) 2011-062230

(51) Int. Cl. G06F 17/30

(52) U.S. Cl. 707/756; 707/E17.045

(57) ABSTRACT

In a digital camera, a GPS receiver acquires latitude-longitude data, and the data are stored in a storage block while being added to data pertaining to a photographed image. When the thus-acquired latitude-longitude data show a neighborhood of a previously-registered home, an image processing block converts the latitude-longitude data into null data and stores the image data into the storage block while adding text data “Home” to the null data. When the acquired latitude-longitude data do not show any neighborhood of the home, the data are saved in the storage block while accuracy of the data is maintained.

### CROSS REFERENCE TO RELATED APPLICATIONS

This application claims priority to Japanese Patent Application No. 2011-62230 filed on Mar. 22, 2011, which is incorporated herein by reference in its entirety.

### FIELD OF THE INVENTION

The present invention relates to a portable device and, more particularly, to a portable device with a position detection function.

### BACKGROUND OF THE INVENTION

Portable devices capable of detecting locations thereof by utilization of a GPS and the like, such as portable phones and digital cameras, have hitherto been developed.

JP2004-309835A discloses a camera having imaging means that forms an optical image of a subject; image recording means that records the optical image as image information; positioning information input means; display form setting means that sets information about a reproduced display form of positional information; and information recording means that records the positional information and the reproduced display form information in association with the image information. The positional information input means is; for instance, a GPS; and the display form setting means can select any one of proper nouns, namely, latitude and longitude information, an address, and a position.

JP2008-27336A discloses a positional information distribution apparatus including a communication block that exchanges data; a recording block; an image processing block; a browse control block; and a distribution block. The recording block records data pertaining to a photographed image and positional data pertaining to the same in an associated manner. The image processing block performs masking processing for partially hindering disclosure of the photographed image. The browse control block brings data pertaining to the mask-processed, photographed image into a state where a terminal device connected to the positional information distribution apparatus by way of the communication block can browse the data pertaining to the mask-processed, photographed image, thereby bringing mask-processed positional data into a secret state. An authentication block authenticates the terminal device according to authentication information acquired from the terminal device. The distribution block transmits positional data corresponding to a photographed image specified by the terminal device to the terminal device authenticated by the authentication block.

Acquiring positional data by means of a GPS, and the like, and adding the thus-acquired positional data to data pertaining to a photographed image are useful for mapping; for instance, photographed image data onto map data. Further, adding positional data to data pertaining to an image photographed by a user and uploading the image data to a server in order to lay the image data open on the Internet have also been widely practiced.

In the meantime, taking a picture; for instance, at home, and laying image data added with positional data pertaining to the house open to an unspecified number of people can raise security problems.

In JP2008-27336A, the positional information distribution apparatus is configured so as to be able to make mask-processed positional data secret and allow only the authenticated terminal device to acquire positional data corresponding to the image data. However, selectively masking specific positional data; for instance, data pertaining to a user's house, results in complicate processing. Moreover, when the user manages, all by himself/herself, data pertaining to a picture taken by himself/herself through use of an arbitrary terminal device, the user must temporarily cancel masking processing if the positional data are masked, which in turn makes the user cumbersome.

### SUMMARY

The present invention aims at providing a portable device capable of ensuring security of image data added with positional data and convenience of the image data.

The present invention is directed toward a portable device having positional data detection means; image data acquisition means; and means that converts detected positional data into vague information when the positional data show a neighborhood of a preset position, that associates the thus-converted information with image data, and that, when the detected positional data do not show a neighborhood of the preset position, stores the positional data in association with the image data while precision of the positional data is unchanged.

In one embodiment of the present invention, the preset position is a user's home.

In another embodiment of the present invention, the portable device further includes means for automatically setting a position where a built-in battery is in course of being charged as the home.

In yet another embodiment of the present invention, the portable device further includes means for automatically setting a position where a stay is detected for a given period of time or more as the home.

In still another embodiment of the present invention, the vague information is null data.

In yet further embodiment of the present invention, the vague information is data determined by dropping a part of latitude-longitude data including arc-seconds.

In still further embodiment of the present invention, the vague information corresponds data produced by addition of an error to the latitude-longitude data.

In still another embodiment of the present invention the vague information includes text data representing a home.

In a still furthermore embodiment of the present invention, a determination as to whether or not the detected positional data show a neighborhood of the preset position is made according to whether or not the detected positional data show a location falling within a range of a given distance from the preset position; and the given distance is increasingly or decreasingly adjusted according to a region represented by the detected positional data.

The present invention makes it possible to assure security of image data added with positional data and convenience of the image data.

The invention will be more clearly comprehended by reference to the embodiments provided below. However, the scope of the invention is not limited to the embodiments.

### BRIEF DESCRIPTION OF THE DRAWINGS

A preferred embodiment of the present invention will be described in detail by reference to the following drawings, wherein:

FIG. 1 is a block diagram of a digital camera of an embodiment of the present invention; and

FIG. 2 is a processing flowchart of the embodiment.

### DETAILED DESCRIPTION OF THE INVENTION

Referring to the drawings, an embodiment of the present invention is hereunder described by means of taking a digital camera as an example portable device. The embodiment provided below is a mere illustration of the invention, and the present invention shall not be confined to the embodiment.

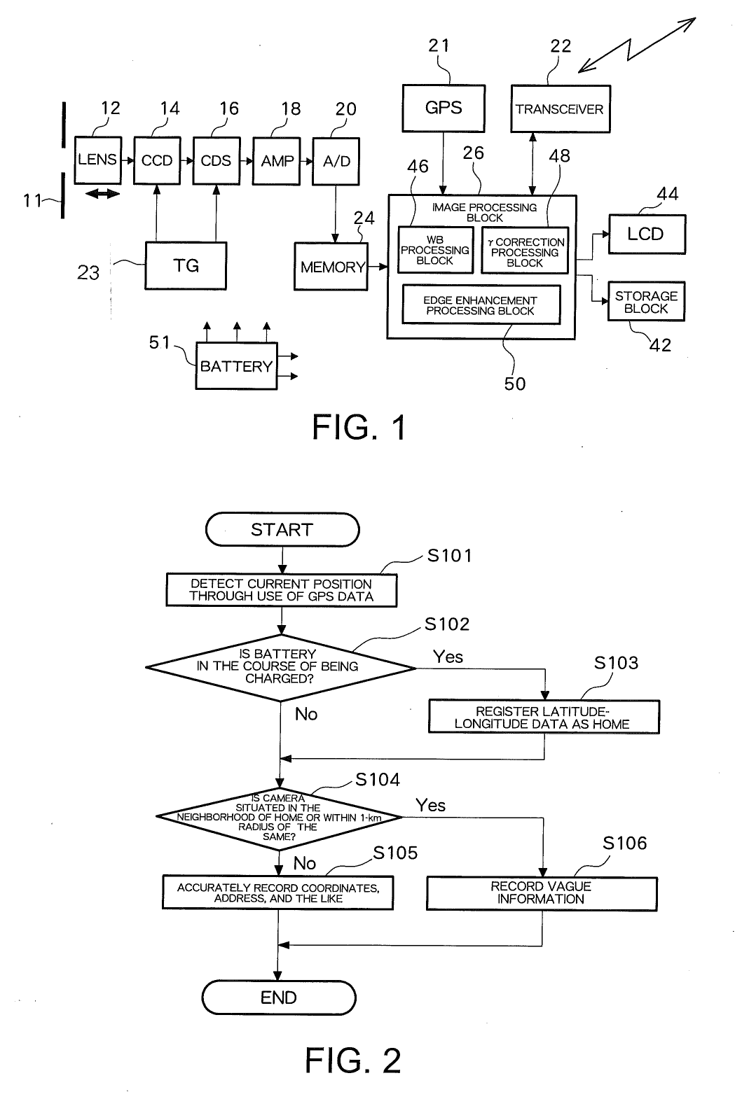

FIG. 1 is a block diagram showing a configuration of the digital camera of the present embodiment. Field light input by way of a diaphragm 11 and a lens 12 comes into a focus on a CCD 14 that is an imaging device. A CPU controls an F-number of the diaphragm 11 and a travel distance of the lens 12. The CCD 14 converts the thus-input field light into an electric signal and outputs the electric signal. The CPU controls timing at which the CCD 14 performs photoelectric conversion by way of a timing generator (TG) 23. In order to acquire a preview image to be displayed on an LCD 44, the CCD 14 accumulates and discharges electric charges at given intervals at all times. When a “take picture” command is received from a user, photoelectric conversion intended for acquiring a preview image is temporarily interrupted. Electric charges are accumulated during an exposure time which would originally be required to photograph an image. The thus-accumulated electric charges are subsequently read out. A CMOS can also be used in place of the CCD 14.

The electric signal output from the CCD 14 undergoes predetermined analogue signal processing performed by a correlated double sampling circuit (CDS) 16 and amplification processing performed by an amplifying circuit (AMP) 18 and is subsequently converted into digital data by an A-D converter (A/D) 20. Digital data produced through conversion are temporarily stored in memory 24 as image data and fed to an image processing block 26.

The image processing block 26 consists of a microprocessor and has a white balance (WB) processing block 46, a γ correction processing block 48, an edge enhancement processing block 50, and a compression-expansion processing block, and others. The image processing block 26 processes the image data temporarily stored in the memory 24 with known image processing. The image data processed with required processing in the image processing block 26 are compressed in a JPEG format, and the like, and subsequently saved in a storage block 42. When a command to reproduce the image data saved in the storage block 42 is received from the user, the image processing block 26 processes the image data read from the storage block 42 with expansion processing and displays the thus-expanded image data on the LCD 44.

A GPS receiver 21 receives a GPS radio wave from GPS satellites and output the thus-received GPS data to the image processing block 26. The image processing block 26 acquires latitude-longitude data from the GPS data; adds the latitude-longitude data to image data; and saves the thus-acquired latitude-longitude data into the storage block 42. For instance, the image processing block 26 records image data along with latitude-longitude data acquired from GPS data by utilization of a tag conforming to an Exif (Exchangeable image file format for digital still cameras) standard.

Pursuant to the command from the user, the image processing block 26 reads the image data saved in the storage block 42 and transmits (uploads) the thus-read data to a server on the Internet by use of a radio transceiver 22. As a matter of course, pursuant to a command from the user, the image processing block 26 can also receive (download) arbitrary image data from the server on the Internet by use of the radio transceiver 22.

Respective blocks of the digital camera operate by receipt of electric power fed by a built-in battery 51. The built-in battery 51 is; for instance, a lithium ion battery that can be connected to an external power source by way of an AC adaptor, to thus be charged.

With such a configuration, when acquiring latitude-longitude data from GPS data and adding the thus-acquired latitude-longitude data to image data, the image processing block 26 changes a form of positional data to be added to the image data according to the thus-acquired latitude-longitude data. More specifically, when the thus-acquired latitude-longitude data relate to a neighborhood of a home of the user of the digital camera; namely, when a photographed image is directed toward the neighborhood of the home, the acquired latitude-longitude data are added to image data after having been converted into vague information rather than being added to the image data with precision of the data being unchanged. As mentioned above, when the acquired latitude-longitude data pertain to the neighborhood of the home, the latitude-longitude data are converted into vague information, whereby user's security is assured. Specifically, in the case where the latitude-longitude data pertain to the neighborhood of the home, if the image data are transmitted to the Internet while the positional data are intactly added to the image data, the third parties who acquired the latitude-longitude data added to the image data can readily ascertain the location of the user's home. However, so long as the latitude-longitude data are previously converted into vague information, the third parties who acquired the image data cannot acquire true positional data pertaining to the neighborhood of the user's home. Consequently, security is assured. The user thereby becomes possible to transmit photographs taken at home; for instance, a family picture taken at home, a picture of a pet taken at home, a picture of a garden taken at home, and other landscape photos taken at home, to the Internet without hesitation, to thus lay the images taken by the user open to the third parties.

In the present embodiment, not all of pieces of the latitude-longitude data are converted into vague information. Attention must be paid to a characteristic that only specific latitude-longitude data pertaining to the neighborhood of the user's home are converted into vague information. Accordingly, when the thus-acquired latitude-longitude data relate to a location other than the neighborhood of the home, the acquired latitude-longitude data are added intact to the image data, and the image data are transmitted to the Internet, so that various applications utilizing the positional data can be implemented.

It is possible to determine whether or not the acquired latitude-longitude data pertain to the neighborhood of the home, so long as the user previously registers the latitude-longitude data pertaining to his/her home and compares the thus registered latitude-longitude data pertaining to the home with the acquired latitude-longitude data. However, previously registering the latitude-longitude data pertaining to the home is cumbersome. Therefore, it is preferable to provide the digital camera with the capability of automatically registering latitude-longitude data pertaining to the user's home.

FIG. 2 is a processing flowchart of the digital camera of the embodiment. First, the GPS receiver 21 receives the GPS data at a predetermined interval or at timing synchronous to the timing at which the user has issued a “Take Picture” command, thereby acquiring latitude-longitude data. Thus, a current position of the digital camera is detected (S101).

Next, the image processing block 26 determines whether or not the built-in battery 51 of the digital camera is in the course of being charged by use of an AC adaptor (S102). The determination is made according to whether or not the AC adaptor is connected to the digital camera or whether or not the built-in battery 51 is in the course of being charged. The image processing block 26 monitors an electric current and a voltage of the built-in battery 51 in order to perform monitoring of a state of charge of the built-in battery 51. For instance, when a charge current is fed to the built-in battery 51, the built-in battery is determined to be in the course of being charged. When the built-in battery 51 of the digital camera is determined to be charged with the AC adaptor, the image processing block 26 considers that the digital camera is now situated at home and that the built-in battery 51 is in the course of being charged with the AC adaptor at home. Thus, the acquired latitude-longitude data are registered as pertaining to a home (S103). In the meantime, when the digital camera is not in the course of being charged with the AC adaptor, the data are not registered as pertaining to the home.

The image processing block 26 compares the thus-acquired latitude-longitude data with the latitude-longitude data registered as pertaining to the home, thereby determining whether or not the thus-acquired latitude-longitude data pertain to a location falling within a 1-km radius of the home (S104). When the thus-acquired latitude-longitude data do not pertain to the location falling within the 1-km radius of the home, the thus-acquired latitude-longitude data are saved in the storage block 42 while being intactly, accurately added to the image data (S105). In the meantime, when the thus-acquired latitude-longitude data pertain to the location falling within the 1-km radius of the home, the thus-acquired latitude-longitude data are converted into vague information and saved in the storage block 42 while being added to the image data (S106). Vague information is specifically generated as below.

(1) Latitude-longitude data are converted into null data, and text data “Home” are added to the null data.

(2) The latitude-longitude data are converted into data including only degrees and arc-minutes, and latitude-longitude including arc-seconds or less are dropped. Address data pertaining to name of a prefecture and name of a city are added as text data.

(3) An error is intentionally added to the latitude-longitude data. The error is generated from; for instance, a user set value and the latitude and longitude data.

(4) Data pertaining to arc-seconds or less, among the sets of latitude-longitude data, are converted into binary digits.

Subsequently, pursuant to a command from the user, required image data are read from the storage block 42, whereupon the thus-read image data are transmitted to the Internet by use of the radio transceiver 22.

As mentioned above, in the present embodiment, when the acquired latitude-longitude data pertain to the neighborhood of the home; namely, a location falling within a 1-km radius of the home, the latitude-longitude data are converted into vague information. For instance, the acquired latitude-longitude data are converted into null data. Further, only text data representing “Home” are added to the positional data. Accordingly, even if image data are transmitted to the Internet while added with the positional data, the positional data that the third parties can acquire from the image data is merely the text “Home,” and hence security of the user's home is assured. Further, since the image data are added with at least the text data “Home,” the user can edit or manage the image data by use of the text data “Home.” For instance, when data pertaining to images taken by the user are mapped on map data, the text data “Home” are added to Exif of the image data. Hence, the image data can be mapped on the location of the home by use of the Exif.

In the present embodiment, when the latitude-longitude data are converted into null data, all of sets of the latitude-longitude data are converted into null data. In addition, only some of the sets of latitude-longitude data can also be converted into null data. For example, only the latitude data are converted into null data. In short, the essential requirement is that the latitude-longitude data should be made vague to such an extent that an accurate position cannot be located by use of the data. In the embodiment, the “vague information” includes all of pieces of information that are inferior to the acquired latitude-longitude data in terms of accuracy and insufficient to locate an accurate position when used alone. The original latitude-longitude data may also be invertible or noninvertible from vague information. However, the original latitude-longitude data are preferably noninvertible from the viewpoint of assurance of sufficient security.

In the embodiment, a determination as to whether or not the digital camera is situated at home is made on the basis of a result of the determination as to whether or not the built-in battery 51 of the digital camera is in the course of being charged with the AC adaptor. As a matter of course, a determination may also be made as to whether or not the digital camera is situated at home by means of another method.

For instance, the digital camera is determined to be situated at home when the built-in battery 51 of the digital camera is in the course of being charged and when acquired latitude-longitude data remain unchanged during a charging period. As a result, the digital camera can be prevented from being erroneously determined to be situated at home or set as a home when the built-in battery is charged in; for instance, a moving body; for instance, a train and a vehicle.

Alternatively, when acquired latitude-longitude data remain unchanged for a predetermined period of time or more, the user is determined to stay at one position for a long period of time, so that the digital camera can also be determined to be situated at home. When WiFi communication is used for the radio transceiver 22, a position where a WiFi connection can be established may also be determined to be a home. Further, latitude-longitude data acquired in a certain period of time (e.g., a night time) can also be determined to show a home.

As a matter of course, before latitude-longitude data pertaining to a home are automatically registered, a menu for providing the user with an inquiry “Do you register the current position as a home?” can also be displayed on the LCD 44 when preset conditions are fulfilled. The location may also be automatically registered as a home only when the user has performed consent operation.

Alternatively, when the user arbitrarily actuates a specific button of the digital camera, latitude-longitude data achieved at a point in time when the button is actuated can also be considered to show the home.

In the present embodiment, the neighborhood of the home is defined as a 1-km radius from home. However, the range of the neighborhood may also be adjusted increasingly or decreasingly according to regional characteristics. For instance, in the case of a megalopolis, the range of a neighborhood is set narrowly when compared with the case of a local area. For instance, in the case of a megalopolis, like Tokyo, the range of a neighborhood is set to 1 km, whereas the range of a neighborhood is set to 5 km in the local area. The region can also be set so as to include a nation. For instance, in the US or Canada, the range of a neighborhood is set to 10 km, whereas the range of a neighborhood is set to 1 km in Japan. Desirably, a region including a nation is detected from acquired latitude-longitude data, and the range of a neighborhood is adjusted increasingly or decreasingly according to the thus-detected region. Specifically, a range of a neighborhood commensurate with a region is previously stored in memory of the image processing block 26. The range of the neighborhood conforming to the thus-detected region is read from the memory and set. The digital camera can also be configured such that a range of a neighborhood previously set by the digital camera according to a region is taken as a default and that the user can adjust, as required, the range of the neighborhood increasingly or decreasingly. Preferably, the value increasingly or decreasingly adjusted by the user is stored in the memory in lieu of the default.

Moreover, in the present embodiment, when acquired latitude-longitude data pertain to a neighborhood of a home, the data are converted into vague information. However, if the user desires that a position other than his/her home be made secret, the position can also be arbitrarily registered. In this case, when the user actuates a specific button at a position desired to be made secret, the image processing block 26 will register the latitude-longitude data acquired at that time. Subsequently, the image processing block compares the thus-registered latitude-longitude data with latitude-longitude data which will be acquired later. When the current position is in close proximity to the location represent by the registered latitude-longitude data, the data are automatically converted into vague information and stored in the storage block 42. When the user enters a title to the position desired to be made secret, the latitude-longitude data are converted into null data, and the title is added as text data to positional data.

In the present embodiment, explanations are given by means of taking the case of still image data as an example. However, even when positional data are added to motion image data, the present invention can also be applied in the same manner as mentioned previously.

Although explanations have been provided in the embodiment by means of taking the digital camera as an example, the present invention can also be applied to a portable phone with a camera or an information terminal with a camera.

### PARTS LIST

11 diaphragm
12 lens
14 ccd
16 cds
18 amp
21 gps receiver
22 radio transceiver
23 timing generator
24 memory
26 image processing block
42 storage processing block
44 lcd
46 processing block
48 correction processing block
50 edge enhancement processing block
51 built-in battery
S101 digital camera detected step
S102 use of AC adaptor step
S103 register latitude-longitude step
S104 location radius step
S105 record coordinates for image data step
S106 record information for image data step

1. A portable device comprising:
positional data detection means;
image data acquisition means; and
means that converts detected positional data into vague information when the positional data show a neighborhood of a preset position, that associates the thus-converted information with image data, and that, when the detected positional data do not show a neighborhood of the preset position, stores the positional data in association with the image data while precision of the positional data is unchanged.

2. The portable device according to claim 1, wherein the preset position is a user's home.

3. The portable device according to claim 2, further comprising means for automatically setting a position where a built-in battery is in course of being charged as the home.

4. The portable device according to claim 2, further comprising means for automatically setting a position where a stay is detected for a given period of time or more as the home.

5. The portable device according to claim 2, wherein the vague information is null data.

6. The portable device according to claim 2, wherein the vague information is data determined by dropping a part of latitude-longitude data including arc-seconds.

7. The portable device according to claim 2, wherein the vague information corresponds to data produced by addition of an error to the latitude-longitude data.

8. The portable device according to claim 5, wherein the vague information includes text data representing a home.

9. The portable device according to claim 1, wherein a determination as to whether the detected positional data show a neighborhood of the preset position is made according to whether or not the detected positional data show a location falling within a range of a given distance from the preset position; and wherein the given distance is increasingly or decreasingly adjusted according to a region represented by the detected positional data.
